(19) United States
(12) Patent Application Publication
(10) Pub. No.: US 2010/0046937 A1
(43) Pub. Date: Feb. 25, 2010

(54) DEVICE AND SYSTEM FOR PRESET FIELD-OF-VIEW IMAGING

(75) Inventor: Yakov Bentkovski, Ness Ziona (IL)

Correspondence Address: OLIFF & BERRIDGE, PLC, P.O. BOX 320850, ALEXANDRIA, VA, 22320-4850, US

(73) Assignee: MTEYE SECURITY LTD., Rosh Ha'ayin (IL)

(21) Appl. No.: 12/444,891

(22) PCT Filed: Oct. 15, 2007
(86) PCT No.: PCT/IL07/01231

§ 371 Date: Sep. 24, 2009

Related U.S. Application Data
(60) Provisional application No. 60/851,763, filed on Oct. 16, 2006.

(51) Int. Cl. G03B 17/00

(52) U.S. Cl. 396/427

(57) ABSTRACT

An assembly for easy installation of a surveillance or other camera on a surface, for example, a vertical surface. Some embodiments include, for example, a camera including an imager having a preset angle relative to a wall, or to a line perpendicular to the floor or ground. In some embodiments, the angle may be a preset or otherwise fixed angle, for example, by bracket for affixing the camera body to the surface.

### FIELD OF THE INVENTION

The present invention relates to the field of security and surveillance systems.

### BACKGROUND OF THE INVENTION

Some security and surveillance systems may include a control unit operatively associated with a camera. For example, in response to a triggering event, the camera may acquire images and may transfer image data to the control unit.

An installation process of a security and/or surveillance camera may require manual calibration of the field-of-view of the camera prior to its physical installation (e.g., onto a wall). For example, an installation technician may need to temporarily position the camera in multiple potential locations, to check the field-of-view of the camera in each such potential location, and then to select a preferred position in which the camera will be installed. Such installation process may require one or more professionals, and may be time-consuming, complicated, and inaccurate.

### SUMMARY OF THE INVENTION

Various embodiments of the invention include, for example, devices, systems and methods for security and/or surveillance.

Some embodiments include, for example, a camera including an imager having a preset angle relative to a wall, or to a line perpendicular to the floor or ground. In some embodiments, the angle may be a preset angle, a fixed angle, a constant angle, a non-variable angle, or an otherwise non-modifiable angle. In some embodiments, the imager may be pre-positioned, pre-slanted, or pre-tilted at a fixed angle.

In some embodiments, the field of view may have boundaries, for example, a first boundary line and a second boundary line. In accordance with some embodiments of the invention, the first boundary line may be horizontal, generally horizontal, parallel to the floor or ground, generally parallel to the floor or ground, perpendicular to a wall, or generally perpendicular to a wall.

In accordance with some embodiments of the invention, the vertical distance between the first boundary line and the floor may be equal to, or substantially equal to, the height of the camera from the floor, e.g., the vertical distance of the baseline of the camera from the floor.

In accordance with some embodiments of the invention, the above-mentioned features of the first boundary line, the field-of-view and/or the imager may exist independent of a specific value of height, e.g., regardless of a specific value of vertical distance between the camera (or its baseline) and the floor or ground.

In accordance with some embodiments of the invention, the field of view of the camera may have a boundary (e.g., the first boundary line) generally at the installation height of the camera (e.g., the vertical distance between the baseline of the camera and the floor or ground).

Some embodiments may include, for example, a security and/or surveillance system having a control unit operatively connected to the camera.

Some embodiments may include, for example, a testing system for an imager of a security and surveillance camera.

Some embodiments may include, for example, a method for installing a security and surveillance camera.

Some embodiments of the invention may allow, for example, quick and/or easy installation of a security/surveillance camera.

Some embodiments of the invention may allow, for example, installation of a security/surveillance camera while the camera is non-activated or non-operational.

Embodiments of the invention may allow various other benefits, and may be used in conjunction with various other applications.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a location having a camera in accordance with some embodiments of the invention;

FIG. 2 is a schematic block diagram illustration of a security/surveillance system in accordance with some embodiments of the invention;

FIG. 3 is a schematic illustration of a top view and a side view of the field of view of a camera or imager in accordance with some embodiments of the invention;

FIG. 4 is a schematic illustration of a field of view of a camera or imager in accordance with some embodiments of the invention;

FIG. 5 is a schematic illustration of three positions of a testing system of an imager in accordance with some embodiments of the invention; and

FIG. 6 is a flow-chart diagram of a method of installing a security/surveillance camera in accordance with some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the invention will be described. For purposes of explanation, specific configurations and details are set forth in order to provide a thorough understanding of the invention. However, it will also be apparent to one skilled in the art that the invention may be practiced without the specific details presented herein. Furthermore, well-known features may be omitted or simplified in order not to obscure the invention.

The term “generally parallel” as used herein (e.g., when referring to a first line and a second line) may include, for example, the first line parallel to the second line, the first line being at an angle of approximately 1 degree relative to the second line, the first line being at an angle of approximately 2 degrees relative to the second line, the first line being at an angle of approximately 3 degrees relative to the second line, the first line being at an angle of approximately 4 degrees relative to the second line, the first line being at an angle of approximately 5 degrees relative to the second line, or the like.

The term “generally perpendicular” as used herein (e.g., when referring to a first line and a second line) may include, for example, the first line being perpendicular to the second line, the first line being at an angle of approximately 90 degrees relative to the second line, the first line being at an angle of approximately 89 degrees relative to the second line, the first line being at an angle of approximately 88 degrees relative to the second line, the first line being at an angle of approximately 87 degrees relative to the second line, the first line being at an angle of approximately 86 degrees relative to the second line, the first line being at an angle of approximately 85 degrees relative to the second line, or the like.

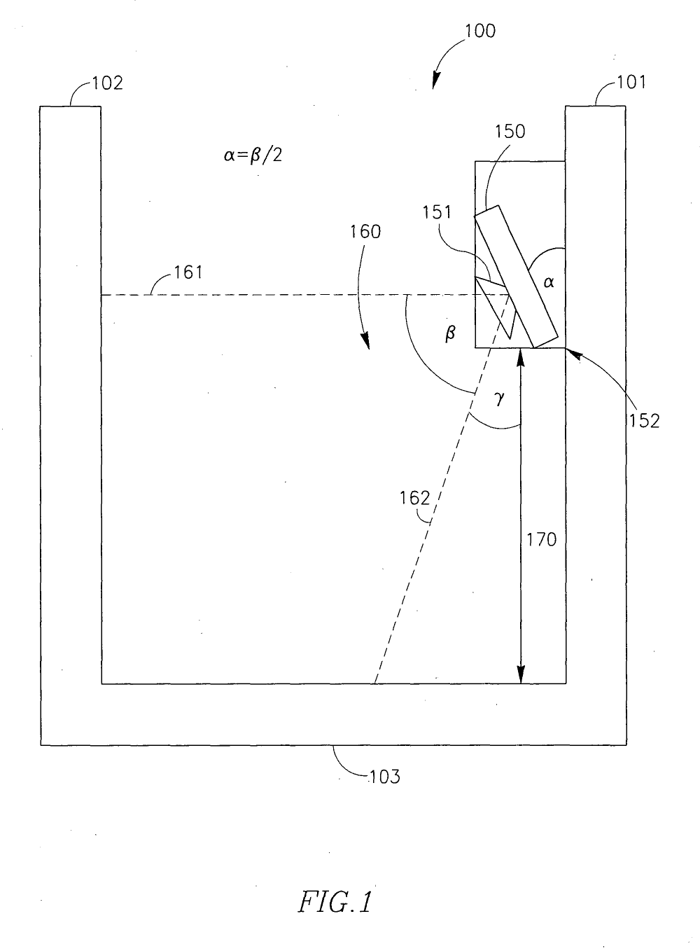

FIG. 1 schematically illustrates a side view of location 100 having a camera 150 in accordance with some embodiments of the invention. Location 100 may be for example, a private location, a public location, a room, an apartment, a house, an office, a yard, an elevator, a vehicle, or the like. Location 100 may be, for example, substantially closed (e.g., a room), substantially open (e.g., a yard). In the example shown in FIG. 1, location 100 may be, for example, a room having a floor or ground 103, and one or more walls, for example, a first wall 101 optionally opposing a second wall 102. In one embodiment, wall 101 and/or wall 102 may be perpendicular, substantially perpendicular or generally perpendicular to the floor or ground 103.

Camera 150 may include, for example, an imager 151 able to acquire images or video. Camera 150 may be installed onto wall 101 or may be placed in proximity to wall 101 using one or more suitable methods, for example, hanging, gluing, affixing, bolting, connecting, placing over a stand or a holder, or the like. Upon installation of camera 150, a baseline 152 of camera 150 may be at a height 170 (e.g., vertical distance) from the floor or ground 103. Height 170 may be equal to any suitable value, for example, approximately two meters, approximately 2.5 meters, approximately seven feet, or the like.

In accordance with some embodiments of the invention, imager 151 may have a preset angle (e.g., angle α) relative to wall 101 or to a line parallel to wall 101. This may allow imager 151 to have a field-of-view 160 having a preset or otherwise known vertical angle (e.g., angle β). In some embodiments, the angle α may be a preset angle, a fixed angle, a constant angle, a non-variable angle, or an otherwise non-modifiable angle. It will be noted that where the field of view of the imager is symmetrical, when the installation tilt angle α is equal to half of the field of view angle β, the upper boundary line of the field of view 161 will be substantially parallel to the ground 103. Accordingly, according to embodiments of the invention, knowing the field of view angle of the imager, a mounting bracket or installation fixture associated with the imager may be provided for mounting on a wall or other vertical surface, such that the imager is tilted by a fixed installation angle α, such that regardless of height of installation 170, the imager may provide a field of view so as to provide useful information to the viewer.

In some embodiments, angle γ indicates an optional, relatively small non-viewable or partially viewable field or zone which the imager 151 may not view or acquire, e.g., less then 1 degree, approximately 1 degree, approximately 2 degrees, approximately 3 degrees, approximately 4 degrees, approximately 5 degrees, or the like. It will be noted that where the upper boundary line of the field of view 161 is substantially parallel to the ground 103, the angle γ is the 90° complement to angle β.

In some embodiments, field of view 160 may have boundaries, for example, a first boundary line 161 and a second boundary line 162. In accordance with some embodiments of the invention, boundary line 161 may be horizontal, generally horizontal, parallel to floor or ground 103, generally parallel to floor or ground 103, perpendicular to wall 103 and/or wall 102, or generally perpendicular to wall 103 and/or wall 102.

In accordance with some embodiments of the invention, the vertical distance between boundary line 161 and the floor 103 may be equal to, or substantially equal to, the height 170 of the camera 150 from the floor 103, e.g., the vertical distance of the baseline 152 from the floor 103.

In accordance with some embodiments of the invention, the above-mentioned features of boundary line 161, field-of-view 160 and/or imager 151 may exist independent of a specific value of height 170, e.g., regardless of a specific value of vertical distance between the camera 150 (or its baseline 152) and the floor 103.

In accordance with some embodiments of the invention, the field of view 160 of the camera 150 may have a boundary (e.g., boundary line 161) generally at the installation height of the camera 150 (e.g., height 170, or the vertical distance between baseline 152 of camera 150 and the floor or ground 103).

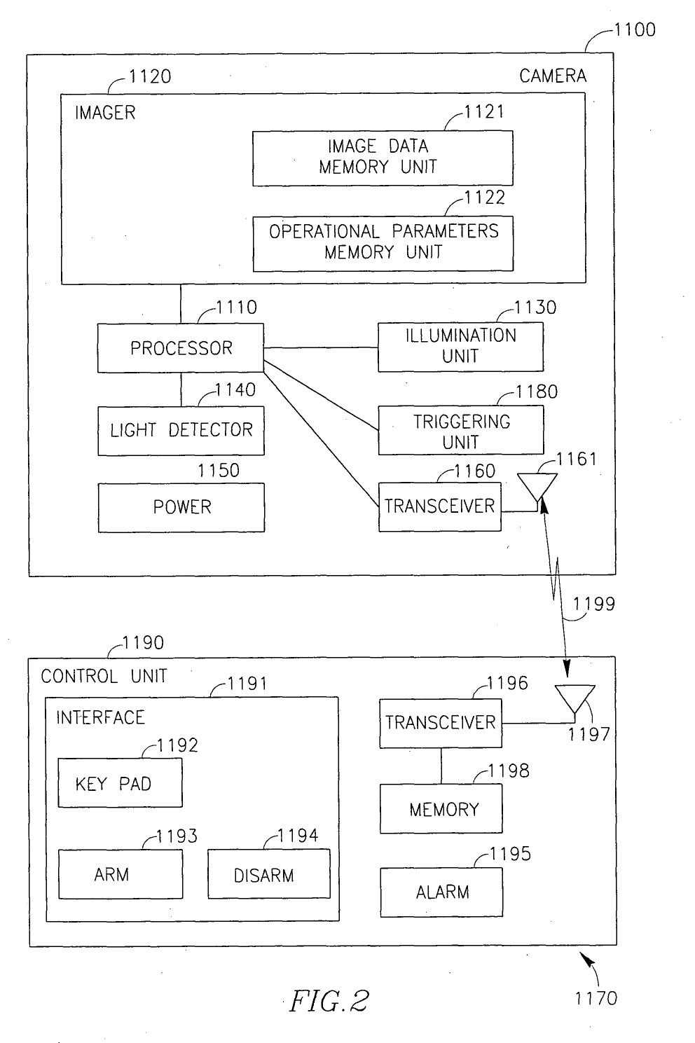

FIG. 2 schematically illustrates a block diagram of a security/surveillance system 1170 in accordance with some embodiments of the invention. System 1170 may include, for example, a control unit 1190 which may be operatively connected to one or more security cameras, e.g., camera 1100.

Camera 1100 may be or may include a fixed position or otherwise installed camera, for example, a zoom camera, a surveillance camera, a traffic camera, a digital camera, or other suitable image acquisition unit. In some embodiments of the present invention, the camera may pan sideways, zoom in/out, and/or change pitch upward/downward. Camera 1100 may include, for example, an imager 1120, a processor 1110, an illumination unit 1130, a power source 1150, a transceiver 1160, a triggering unit 1180, and a light detector 1140. Camera 1100 may include other suitable hardware components and/or software components. In some embodiments, the components of camera 1100 may be inter-connected of operatively associated, and may be enclosed in a suitable housing, enclosure, shell or packaging.

Imager 1120 may include, for example, a Complementary Metal Oxide Semiconductor (CMOS) imager, a Charge Coupled Device (CCD) imager, or other suitable image sensor, video sensor, image acquisition unit or video acquisition unit. In one embodiment, for example, imager 1120 may include a single-chip CMOS having an integrated image signal processor and a Joint Photographic Experts Group (JPEG) codec, e.g., imager model CoderCam TC5740 available from TransChip of Ramat Gan, Israel (www.TransChip.com), or other suitable imager.

Imager 1120 may be able to acquire images or video in accordance with one or more standard or non-standard resolutions, for example, Video Graphics Array (VGA) resolution of 640 by 480 pixels, Quarter VGA (QVGA) resolution of 320 by 240 pixels, Sub-QVGA resolution of 160 by 120 pixels, Common Intermediate Format (CIF) resolution of 352 by 288 pixels, or other suitable resolutions. Imager 1120 may acquire images or video in accordance with one or more standard or non-standard color depth, for example, 2 colors (e.g., black and white, or monochrome), 4 colors, 16 colors, 256 colors, 65,536 colors, or the like.

In some embodiments, image 1120 may be able to acquire images or video illuminated by a visible light, e.g., white light or colored light. In alternate embodiments, image 1120 may be able to acquire images illuminated by non-visible light, invisible light, Infra Red (IR) light, or near-IR light; in such cases, for example, imager 1120 may not include an IR coating, e.g., to allow reception and acquisition of IR light, or imager 1120 may include or may be an IR-sensitive imager.

Although part of the discussion herein may relate, for exemplary purposes, to camera 1100 and/or imager 1120 able to acquire images, embodiments of the invention are not limited in this regard and may be used, for example, in conjunction with camera 1100 and/or imager 1120 able to acquire video or image streams, and/or compressed or encoded image data and/or video data.

Imager 1120 may include a memory unit 1121 to store data of one or more images or video acquired by imager 1120. The data stored in memory unit 1121 may be non-compressed, compressed or encoded, e.g., in accordance with JPEG standard, Motion JPEG (M-JPEG) standard, Moving Picture Experts Group (MPEG) standard, MPEG-2 standard, MPEG-4 standard, or other suitable compression standards or encoding standards.

Imager 1120 may optionally include a memory unit 1122 to store values of one or more operational parameters of imager 1120. The operational parameters may include for example, exposure period of time (e.g., in milliseconds), frame capture rate (e.g., in frames per second), analog gain, digital gain, brightness level, contrast level, saturation level, hue level, gamma level, or other parameters. In one embodiment, imager 1120 may not include a memory unit 1122 to store values of operational parameters, and processor 1110 may control (e.g., externally to the imager 1120) such operational parameters and their corresponding values. In another embodiment, values of operational parameters may optionally be stored in, or set by, an imager controller, which may be integrated with imager 1120 or operatively associated with imager 1120.

In the exemplary embodiment shown in FIG. 2, memory units 1121 and 1122 may be implemented as two separate sub-units of imager 1120. In other embodiments, memory units 1121 and 1122 may be implemented as one unit, or as more than two units or sub-units. In some embodiments, memory units 1121 and 1122 may be external to imager 1120, for example, implemented as separate one or more units of camera 1100 and operatively associated with imager 1120.

Memory units 1121 and/or 1122 may include, for example, a Random Access Memory (RAM), a Dynamic RAM (DRAM), a Synchronous DRAM (SD-RAM), a Flash memory, a memory card, a memory stick, a volatile memory, a non-volatile memory, a cache memory, a buffer, a memory unit able to store a value or a result in a calculated equation or formula, a short term memory unit, a long term memory unit, a hard disk drive, a floppy disk drive, a Compact Disk (CD) drive, a CD-ROM drive, or other suitable removable or non-removable storage units or memory units.

Illumination unit 1130 may include, for example, one or more “flash” illumination units or Light Emitting Diodes (LEDs). In some embodiments, illumination unit 1130 may include, for example, a solid-state high-brightness “flash”-type LED, a solid-state lamp, or a non-xenon illumination unit. In some embodiments, illumination unit 1130 may be able to illuminate, for example, white light, colored light, or other visible light. In alternate embodiments, illumination unit 1130 may be able to illuminate, for example, non-visible light, invisible light, IR light, or near-IR light. Illumination unit 1130 may illuminate, for example, in response to an illumination command received from processor 1110 and/or imager 1120.

Light detector 1140 may include, for example, a light sensor, a light meter or a light measurement unit able to sense, detect and/or measure light, e.g., the level of light, visible light, or ambient visible light in the area or room in which camera 1100 is located. In some embodiments, light detector 1140 may include a detector of visible light, or a detector non-sensitive to IR light. In one embodiment, for example, light detector 1140 may include a visible light sensor model LX1970 available from Microsemi Integrated Products of California (www.MicroSemi.com), or other-suitable light sensors. Optionally, in some embodiments, light detector 1140 may include, or may be positioned in proximity to, a light tunnel or a suitable cone-shaped or tunnel-shaped cavity, which may assist in focusing or trapping light for detection or measurement by light detector 1140. In some embodiments, one or more readings of measure light may be used, for example, by processor 1110, to calibrate the imager 1120, to determine and set configuration values for operational parameters of imager 1120, and/or to determine whether to activate the illumination unit 1130 during image acquisition.

Processor 1110 may include, for example, processor, a Central Processing Unit (CPU), a Digital Signal Processor (DSP), a microprocessor, a controller, a low-power processor or controller, a chip, a microchip, an Integrated Circuit (IC), an Application-Specific IC (ASIC), or any other suitable multi-purpose or specific processor or controller. In one embodiment, for example, processor 1110 may include a mixed signal microprocessor model MSP430F135, model MSP430x13x, model MSP430x14x, or model MSP430x14x1, available from Texas Instruments of Texas (www.TI.com), or other suitable controller or processor. Processor 1110 may, for example, send, commands or instructions to imager 1120 and/or illumination unit 1130, send and/or receive data through transceiver 1160, perform calculations in an image or video acquisition process, perform data encoding or compression, and/or control the operation of one or more components of camera 1100. In one embodiment, processor 1110 may be integrated with transceiver 1160, for example, as a single component or as a single Integrated Circuit (IC).

Transceiver 1160 may include, for example, a two-way wireless transceiver. For example, transceiver 1160 may transmit image data, acquired by imager 1120 and/or stored in memory unit 1121, to an external receiver or system, e.g., to control unit 1190. Additionally or alternatively, transceiver 1160 may receive data or instructions transmitted to camera 1100 from an external transmitter or system, e.g., from control unit 1190.

Transceiver 1160 may include, for example, a transmitter-receiver unit or a transmitter unit and a receiver unit, and may operate in accordance with one or more wireless communication standards or protocols, for example, Bluetooth ZigBee, 802.11, 802.11a, 802.11b, 802.11g, 802.16, Wi-Fi, Wi-Max, a proprietary wireless communication protocol, a customized or modified wireless communication protocol, or the like. Transceiver 1160 may optionally include, or may be connected to, an internal or external antenna 1161 able to transmit and/or receive wireless communication signals. In one embodiment, transceiver 1160 may be integrated with processor 1110, for example, as a single component or as a single Integrated Circuit (IC).

Power source 1150 may provide power to one or more components of camera 1100, e.g., processor 1110, imager 1120, illumination unit 1130, and/or transceiver 1160. In some embodiments, power source 1150 may be internal to camera 1100, and may include, for example, one or more rechargeable or non-rechargeable batteries or power-cells, such that camera 1100 may be self-powered or battery operated, and may not be operatively connected to an external power source. For example, in one embodiment, power source 1150 may include one or more “AA” batteries, one or more “AAA” batteries, or the like.

Triggering unit 1180 may include, for example, a triggering source, a motion detector, a movement sensor, a fire detector, a smoke detector, a temperature sensor, an impact sensor, a touch sensor, an entry detector, an exit detector, a volume sensor, an audio sensor, a sound sensor, or other sensor, monitor or detector able to generate a signal indicating a triggering event. The triggering event may include, for example, a motion or movement in proximity to camera 1100 or in the field-of-view of imager 1120, an entrance or an exit of a person to an area or a room monitored by camera 1100, a change of a property of an area or room monitored by camera 1100, or the like. In one embodiment, the triggering event may include, for example, reception of a triggering command from an input unit or a command unit, e.g., through a wired or wireless communication link.

In some embodiments, upon detection or sensing of a triggering event, the triggering unit 1180 may generate a signal (“triggering signal”), which may be transferred, for example, to processor 1110 and/or to imager 1120. The triggering signal may, for example, trigger imager 1120 (e.g., directly or through processor 1110) to acquire one or more images.

Although imager 1120, light detector 1140 and processor 1110 are shown as separate components, embodiments of the invention are not limited in this regard, and may include other suitable implementations. In some embodiments, for example, light detector 1140 may be integrated within imager 1120; additionally or alternatively, processor 1110 may be integrated within imager 1120, or may be a sub-unit of imager 1120. In one embodiment, imager 1120 may be used to perform light detection and/or light measurement operations, e.g., instead of light detector 1140. In another embodiment, imager 1120 may be used to determine and/or set the operational parameters of imager 1120 based on the measured level of light, e.g., instead of processor 1110. Other suitable implementations may be used in accordance with embodiments of the invention.

Control unit 1190 may include, for example, an interface 1191, an alarm 1195, a transceiver 1196, and a memory unit 1198. Control unit 1190 may be implemented, for example, as a device able to be operatively connected to camera 1100 and able to control camera 1100. In some embodiments, control unit 1190 may be implemented as one or more modules or sub-units, for example, a media gateway sub-unit or module able to communicate with camera 1100, an input module or sub-unit able to receive user input, a communication module or sub-unit able to communicate with camera 1100, a controller module or sub-unit able to provide instructions to control the operation or the status of camera 1100, or other suitable modules or sub-units.

Transceiver 1196 may include, for example, a two-way wireless transceiver. For example, transceiver 1196 may receive image data or video data acquired by camera 1100, and/or may transmit instructions to camera 1100.

Transceiver 1196 may include, for example, a transmitter-receiver unit or a transmitter unit and a receiver unit, and may operate in accordance with one or more wireless communication standards or protocols, for example, Bluetooth, ZigBee, 802.11, 802.11a, 802.11b, 802.11g, 802.16, Wi-Fi, Wi-Max, a proprietary wireless communication protocol, a customized or modified wireless communication protocol, or the like. Transceiver 1196 may optionally include, or may be connected to, an internal or external antenna 1197 able to transmit and/or receive wireless communication signals.

Interface 1191 may include, for example, an input unit allowing a user to provide instructions to activate, de-activate or otherwise control camera 1100. In some embodiments, for example, interface 1191 may optionally include a keypad 1192 allowing a user (e.g., an authorized user or a system manager) to input a password, Personal Identification Number (PIN) or a code, which may be required for providing further instructions to camera 1100. In some embodiments, interface 1191 may optionally include an “arm” button 1193, e.g. a button allowing a user to provide a command to arm or activate the camera 1100, and/or a “disarm” button 1194, e.g., a button allowing a user to provide a command to disarm or de-activate the camera 1100. Other suitable components may be included with, or may be associated with, interface 1191, for example, a sub-unit for physical security authentication which may require a user to turn a key or pass a card in order to provide commands to camera 1100.

Alarm 1195 may include, for example, a unit able to provide a pre-defined alert notification, e.g., an audible alert, a visual alert, a message or indication of alert, or the like.

Memory unit 1198 may, for example, store data of one or more images acquired by camera 1100. The data stored in memory unit 1198 may be non-compressed, compressed or encoded, e.g., in accordance with JPEG standard, Motion JPEG (M-JPEG) standard, Moving Picture Experts Group (MPEG) standard, MPEG-2 standard, MPEG-4 standard, or other suitable compression standards or encoding standards.

Memory unit 1198 may include, for example, a Random Access Memory (RAM), a Dynamic RAM (DRAM), a Synchronous DRAM (SD-RAM), a Flash memory, a memory card, a memory stick, a volatile memory, a non-volatile memory, a cache memory, a buffer, a short term memory unit, a long term memory unit, a hard disk drive, a floppy disk drive, a Compact Disk (CD) drive, a CD-ROM drive, or other suitable removable or non-removable storage units or memory units.

Control unit 1190 and/or camera 1100 may include other suitable hardware components and/or software components.

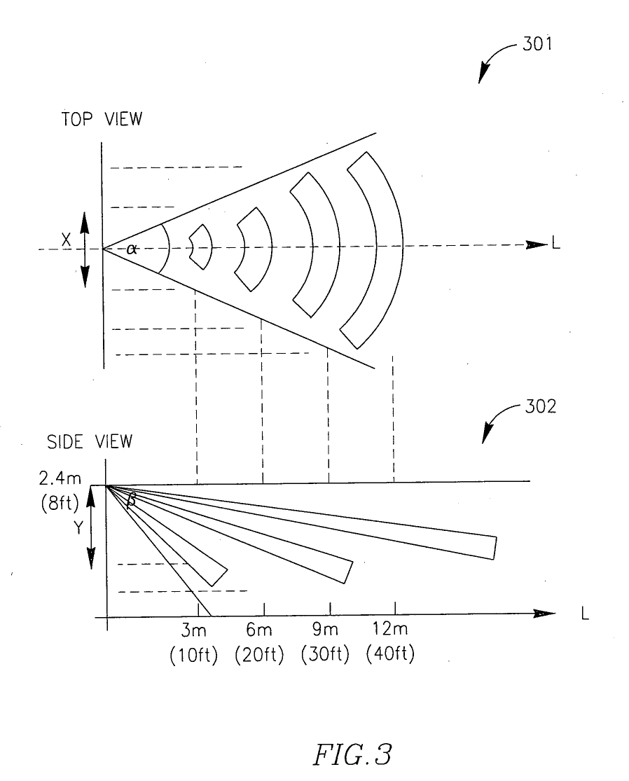

FIG. 3 schematically illustrates a top view 301 and a side view 302 of the field of view of a camera or imager in accordance with some embodiments of the invention. In one embodiment, for example, an angle α may indicate a horizontal field of view, and an angle β may indicate a vertical field of view.

In some embodiments, a size X of a top view may be a function of the angle α and a horizontal distance L. For example, in some embodiments, the following equation may hold true:

X=2×L×tan(α/2) Equation (1)

In some embodiments, a size Y of a side view may be a function of the angle β and the horizontal distance L. For example, in some embodiments, the following equation may hold true:

Y=L×tan(β) Equation (2)

In one embodiment, for example, the angle α may be equal to 43.74 degrees, and the angle β may be equal to 33.68 degrees. In accordance with Equation (1) and (2), if the value of L is 1 meter, then the value of X is approximately 0.803 meters and the value of Y is approximately 0.666 meters; if the value of L is 2 meters, then the value of X is approximately 1.606 meters and the value of Y is approximately 1.333 meters; if the value of L is 3 meters, then the value of X is approximately 2.408 meters and the value of Y is approximately 1.999 meters; if the value of L is 6 meters, then the value of X is approximately 4.817 meters and the value of Y is approximately 3.998 meters; if the value of L is 9 meters, then the value of X is approximately 7.225 meters and the value of Y is approximately 5.998 meters; and if the value of L is 12 meters, then the value of X is approximately 9.633 meters and the value of Y is approximately 7.997 meters.

Other suitable values, distances, angles, equations or calculations may be used in accordance with embodiments of the invention.

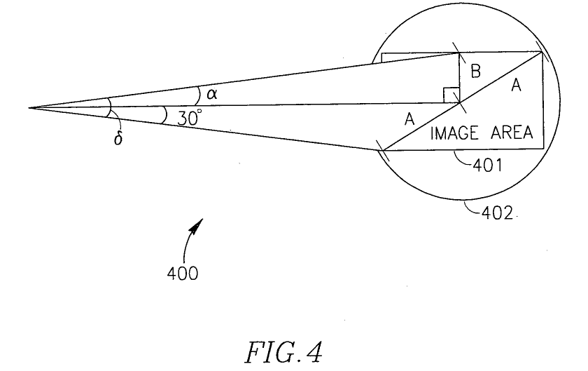

FIG. 4 is a schematic illustration of a field of view δ of a camera or imager in accordance with some embodiments of the invention. A rectangular area 401 is shown, representing, for example, a substantially rectangular area of an imager. The rectangular area 401 may have height 2b and diagonal 2a, and may be surrounded by a circle 402.

In some embodiments, the field of view δ may be divided into two angles, for example, a first angle which may be equal to 30 degrees, and a second angle α which may be equal to (δ−30) degrees. In one embodiment, the ratio between the angle α and 30 degrees, may be equal to the ratio between b and a. For example, the following equation may hold true:

α=(b/a)×30 Equation (3)

Other suitable values, angles, equations or calculations may be used in accordance with embodiments of the invention.

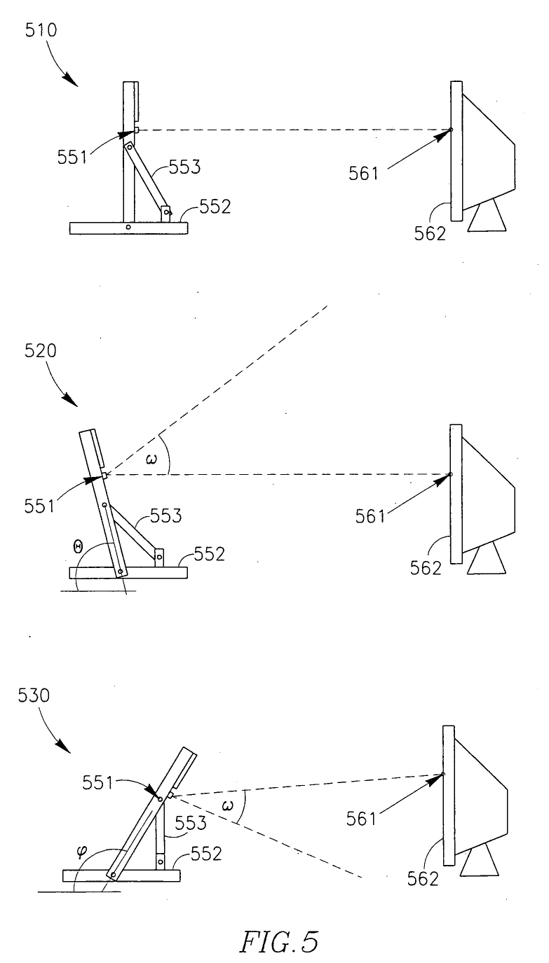

FIG. 5 schematically illustrates three positions 510, 520 and 530 of a testing system of an imager in accordance with some embodiments of the invention. The testing system may include, for example, an imager 551 mounted on a base 552 having a mechanism 553 able to modify the positioning angle of the imager 551. The testing system may further include a relatively small object 561 (e.g., a mark), optionally mounted on or included in a relatively bigger object 562 (e.g., a computer monitor).

As shown in position 510, the object 561 and the imager 551 may be positioned at substantially the same height.

As shown in position 520, the mechanism 553 may be tilted or positioned such that the object 553 appears at the lowest edge of the field of view of the imager 551 (or at the lowest edge of an image acquired by the imager 551), and the angle θ may be recorded

As shown in position 530, the mechanism 553 may be tilted or positioned such that the object 553 appears at the highest edge of the field of view of the imager 551 (or at the highest edge of an image acquired by the imager 551), and the angle φ may be recorded.

The imager 551 may have a field of view ω. In some embodiments, angle ω may be equal to the difference between angle φ and angle θ. In one embodiment, for example, the following equation may hold true:

ω=φ−θ Equation (4)

Other suitable values, angles, equations or calculations may be used in accordance with embodiments of the invention.

Thus, knowing the diagonal field of view of the lens, the horizontal & vertical field of view may be calculated based on the imager horizontal and vertical perspective. After calculating the horizontal and vertical field of view, the installation angle α (FIG. 1) of the camera may be set.

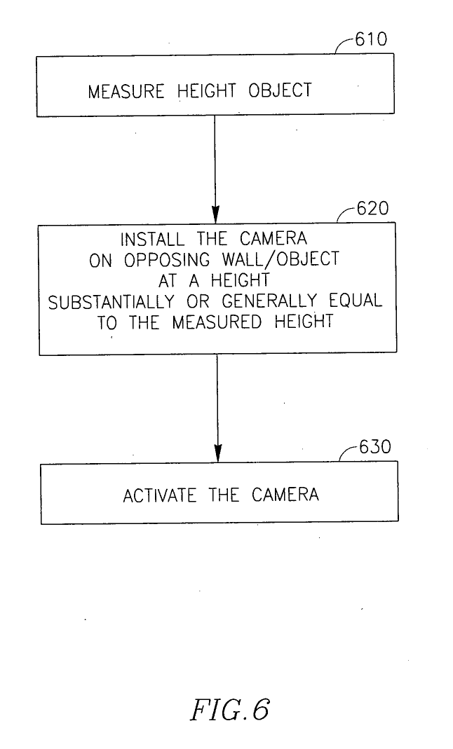

FIG. 6 is a flow-chart diagram of a method of installing a security/surveillance camera in accordance with some embodiments of the invention. The method may be used, for example, in conjunction with camera 150 of FIG. 1.

As indicated at box 610, the method may include, for example, measuring or estimating a height of an object (e.g., an upper or top-most edge of the object) which is desired to be imaged or monitored by the security/surveillance camera. For example, if it desired to monitor a window, the height of the upper or top-most edge of window may be measured or estimated, e.g., from the floor or ground.

As indicated at box 620, the method may include, installing the security/surveillance camera on an opposing wall or object, at a height substantially or generally equal to the height measured at box 610. In some embodiments, installing may include, for example, hanging, gluing, affixing, bolting, connecting, placing over a stand or a holder, or the like.

In some embodiments, the operations of boxes 610 and 620 may be performed on a precise basis or on a non-precise basis, e.g., using a “rough”, estimate or human estimate instead of a precise measurement. For example, in order to install a security/surveillance camera to monitor an object, the method may include installing the security/surveillance, camera at substantially or generally the same height of the object, e.g., without precise height measurement.

In one embodiment, during the operations of boxes 610 and 620, the security/surveillance camera may be turned on, turned-off, activated, de-activated, connected to or disconnected from a power source, operational, partially operational, or non-operational.

As indicated at box 630, the method may optionally include activating the security/surveillance camera, for example, if the security/surveillance camera was non-activated or non-operational during the operations of boxes 610 and 620.

Other suitable operations or sets of operations may be used in accordance with embodiments of the invention.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An assembly for preset field of view imaging comprising:
an imager having a field of view angle;
means for affixing said imager to a surface at a fixed angle such that a boundary of said field of view is substantially perpendicular to said surface.

2. The assembly of claim 1, further comprising a camera body attached to said imager.

3. The assembly of claim 2, wherein said means for affixing comprises a bracket for attaching said camera body to said surface.

4. The assembly of claim 3, wherein said bracket is configured to affix said camera body to the surface at an installation angle.

5. The assembly of claim 4, wherein said installation angle equals half of said field of view angle.
